(19) United States
(12) Patent Application Publication
(10) Pub. No.: US 2002/0067246 A1
(43) Pub. Date: Jun. 6, 2002

(54) Signaling device

(76) Inventor: Dieter Woitscholl, Jatznick (DE)

Correspondence Address: TECHNOPROP COLTON, L.L.C., P O BOX 567685, ATLANTA, GA, 311567685

(21) Appl. No.: 09/834,146

(22) Filed: Apr. 12, 2001

(30) Foreign Application Priority Data
Apr. 14, 2000 (DE) 200 06 963.2

(51) Int. Cl. G08B 5/00

(52) U.S. Cl. 340/332; 340/331

(57) ABSTRACT

The invention relates to a signaling device for the generation of a light beam, in particular a portable searchlight. The signaling device comprises a housing (11) and at least one illuminant (16) arranged in the housing (11). Also arranged in the housing (11) is at least one source of current (17). One special feature of the invention is that the or each illuminant (16) can be activated by a wireless remote control.

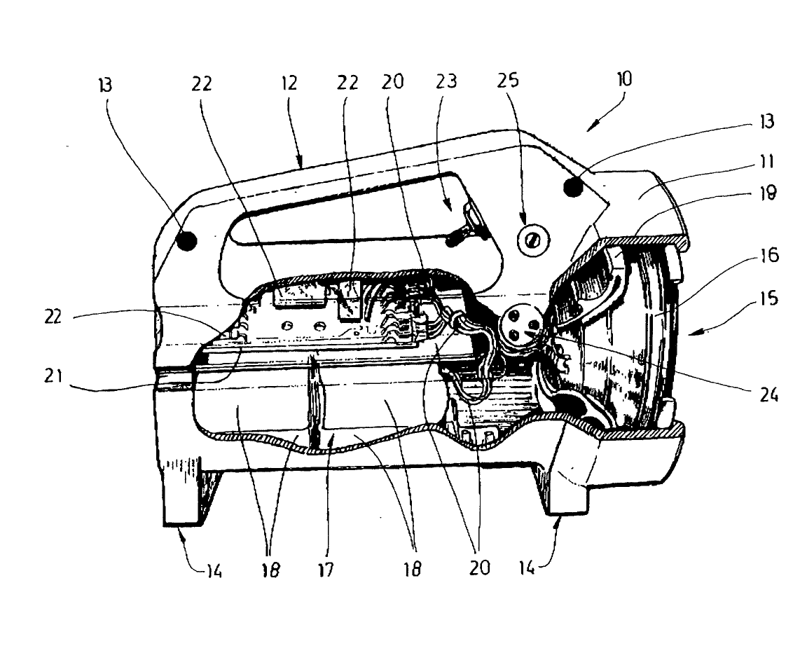

A further signaling device according to the invention is characterized in that a drop in the capacity of the or each source of current (17) below a given threshold value can be signaled by optical means.

It is further proposed that a plurality of illuminants (16), each with a different power consumption, are to be provided such that when the capacity of the or each source of current (17) drops below a given threshold value, only the or each illuminant (16) with the least power consumption is operated.

### DESCRIPTION

The invention relates to a signaling device pursuant to the preamble of claim 1.

Such signaling devices are known in many forms, such as flashlights or searchlights, and can be employed for variety of applications.

The objective of the present invention is to improve and further develop known signaling devices.

According to the invention, this objective is solved by the characterizing features of claim 1. By virtue of the fact that the or each illuminant can be actuated by wireless remote control, the user is able to move a distance away from the signaling device without losing control over the actuation of the illuminant or illuminants. Furthermore, there are cases when it is not possible or convenient to carry along a signaling device. In this case the signaling device can be mounted at a given position and operated from the actual work site. The signaling device according to the invention can, for example, be used by police officers in the field, special security forces, etc. In this case the signaling device can be mounted on a vehicle and activated whenever needed. Thus it is possible to achieve an element of surprise when chasing suspects in that the suspect would expect law officers to be in the vicinity of the signaling device. The advantage here is that the generated light beam provides no indication of the actual position of the operator.

According to a further development, which can represent an independent solution of the aforementioned objective according to claim 2, a drop in the capacity of the or each source of current below a given threshold value can be signaled by optical and/or acoustic means. In this way the end of the actual service time can be signaled well before the current source runs down completely. The user can then switch to a different power source in good time or connect the signaling device to an external source of current.

A further proposal is to assign optical and/or acoustic signalizing means to the housing and/or remote control. In this manner, the end of the actual service time will not only be displayed at the signaling device but also at the remote control. In a preferred embodiment, the optical and/or acoustic means take the form of a diode or a loudspeaker. The aforementioned products are mass goods which can be manufactured at little expense, thus increasing the manufacturing costs for the signaling device according to the invention by only a very small margin.

Also provided is that the intensity of the generated light beam can be preferably continuously regulated, in particular by means of the remote control. By so doing, the light beam can be adapted to the brightness of the surroundings. It is further proposed that the remote control also be configured for turning the or each illuminant on and off. In this way, the remote control is designed to activate all essential functions of the signaling device.

According to one further development, which may be an independent solution of the objective set forth at the outset according to claim 15, a plurality of illuminants differing in power consumption are provided, so that when the capacity of the or each source of current drops below a given threshold value, the or each illuminant is merely operated with lower power consumption. Such a configuration extends the maximum service life of the signaling device. For this purpose, at least two illuminants with different power consumption are arranged in the housing. When there is sufficient capacity in the source of current, either the illuminant with the greater power consumption or both illuminants can be operated together thus making it possible to generate a light beam with maximum intensity. When the capacity of the source of current drops below a given threshold value, at least one illuminant is turned off, thus reducing power consumption on the whole and extending the operating time.

Further details of the invention will be described below as based on the drawing of a preferred exemplary embodiment. The sole FIGURE of the drawing shows a perspective side view of a signaling device.

The FIGURE shows a signaling device is a partially exploded view, specifically that of a portable searchlight 10. However, the signaling device can just as easily be a flashlight, spotlight, lamp, beacon, flash or combinations thereof. The portable searchlight 10 has a housing 11, which is essentially manufactured in a single piece. The housing 11 can be made of polyethylene, for example. The housing 11 is formed as a handle 12 in the region of an upper side. On either side of the handle 12 are means for attaching a carrying belt, namely two eyelets 13. In the region of a bottom side the housing takes the form of support surfaces, namely base feet 14, by means of which the portable searchlight 10 can be set down on a base support. On one side the housing 11 also features an opening, namely a circular recess 15.

Arranged inside the housing 11 is an illuminant 16. In the example shown, the illuminant 16 comprises a 100-watt halogen lamp, for example. The illuminant 16 is arranged in the region of the recess 15 of the housing 11. The illuminant 16 extends across the entire surface of the recess 15 and abuts the edge of the recess 15 at the housing 11. Also positioned between illuminant 16 and housing 11 is a sealing ring 19??, which keeps dust and/or moisture from entering the housing 11.

The illuminant 16 is supported within the housing 11 by a profile 19 on the housing 11. The profile 19 is made of an elastic material, such as plastic or rubber, and surrounds the illuminant 16 on a side turned away from the recess 15. By virtue of the profile 19, jolts impacting the housing 11 from the exterior, e.g. when the portable searchlight 10 is set down abruptly, are cushioned, thus preventing damage to the illuminant 16.

Also arranged inside the housing 11 is a source of current 17 for supplying energy to the illuminant 16. In the present case, the source of current 17 comprises a plurality of accumulators 18, which are connected to the illuminant 16 by wires 20. Alternatively, batteries may also be used for supplying the current. For operating the portable searchlight 10, the housing is provided with an on/off switch which is connected by wires 20 to the accumulators 18 and illuminant 17.

Means for providing acoustic and/or optical signals can also be arranged in the region of the housing 11, such as a (luminous) diode or a loudspeaker. These means are used to signal the approaching end of the operating period, i.e. the time when the energy stored in the accumulators 18 is used up or when the capacity of the accumulators 18 is exhausted. For determining the capacity of the accumulators 18, there is arranged in the housing 11 a circuit arrangement comprising electronic components 22 on a board 21. As soon as the capacity of the accumulators 18 drops below a given threshold value, this is signaled by the acoustic and/or optical means. To this end, the circuit is connected on one hand to the accumulators, and on the other hand to the acoustic and/or optical means, which are automatically activated by the circuit. Instead of measuring the capacity of the accumulators 18, it is also possible to measure the voltage in order to determine the remaining period of operation. Thus, the optical and/or acoustic means can be activated 5 minutes before the end of the operating period, for instance. The time interval between the warning signal and the actual end of the operating period can be adjusted by programming the circuit accordingly.

It is also possible to have a plurality of illuminants 16 arranged in the housing. Thus, two halogen lamps varying in power consumption and the corresponding luminosity can be used, for example a 50-watt halogen lamp and a 15-watt halogen lamp. Depending on the capacity of the accumulators 18, the operation of the two illuminants 16 is automatically regulated by the circuit. In this case, the housing 11 is provided with a single on/off switch 23 for operating the portable searchlight 10. As long as sufficient capacity is present, both illuminants 16 or are operated or, alternatively, the illuminant 16 with the greater power consumption is operated. As soon as the capacity drops below a given threshold value, the illuminant 16 with the greater power consumption is turned off and operation continues using only the illuminant 16 with the smaller power consumption.

Furthermore, the illuminants 16 can be assigned a control element for regulating the intensity of the generated light beam, such as a control with which the intensity can be regulated, preferably in a continuous manner. In the shown exemplary embodiment, the housing 11 also has a socket 24. By means of the socket 24 the source of current 17 and/or the or each illuminant 16 can be connected to an external power source. In this manner, the or each illuminant 16 can be operated independently of the source of current 17 arranged inside the housing 11. Furthermore, the external power source can be used to charge the accumulators 18. The housing also has a safety switch 25 for transport. By virtue of the safety switch 25, operation of the illuminant 16 can be shut off independently of the switch 23. This can be used to avoid an inadvertent activation of the portable searchlight 10 during transport.

Advantageous is the operation of the portable searchlight 10 by means of a wireless remote control. To this end the remote control can have an on/off switch whose function corresponds to the switch 23 on the housing 11. In this way, the or each illuminant 16 can be activated. Furthermore, the remote control can have a control for regulating the intensity of the generated light beam. Preferably, however, the remote control is provided with one switch with which the two aforementioned functions can be controlled in combination, such as a key which when briefly pressed turns the or each illuminant 16 on or off. Pressing the key longer activates the intensity control for the generated light beam, i.e. acting as a dimmer switch. Furthermore, the remote control can feature the same optical and/or acoustic means for signaling the end of the operating period as those employed in the portable searchlight 10.

The remote control can run off its own source of current. Thus, for example, one or more batteries or accumulators can be arranged in a housing of the remote control. The remote control is preferably one employing an infrared radio control with a range of 300 to 400 meters, for example. But in principle all other types of remote control devices are conceivable.

1. Signaling device for generating a light beam, in particular a portable searchlight, which comprises a housing (11) and at least one illuminant (16) arranged in the housing (11) and at least one source of current (17) arranged in the housing (11). characterized in that at least one illuminant (16) can be activated by a wireless remote control.

2. Signaling device in particular according to claim 1, characterized in that a drop in the capacity of at least one source of current (17) below a given threshold value can be signaled by optical means.

3. Signaling device according to claim 2, characterized in that a drop in the capacity of at least one source of current (17) below a given threshold value can be signaled by acoustic means.

4. Signaling device according to claim 2, characterized in that the optical means is assigned to the housing (11).

5. Signaling device according to claim 2, characterized in that the optical means is assigned to the remote control.

6. Signaling device according to claim 3, characterized in that the acoustic means is assigned to the housing (11).

7. Signaling device according to claim 3, characterized in that the acoustic means is assigned to the remote control.

8. Signaling device according to claim 2, characterized in that optic means are formed by a diode.

9. Signaling device according to claim 3, characterized in that a loudspeaker is provided for acoustic signaling.

10. Signaling device according to claim 1, characterized in that the intensity of the generated light beam can be continuously regulated by the remote control.

11. Signaling device according to claim 1, characterized in that the remote control is configured to turn at least one illuminant (16) on and off.

12. Signaling device according to claim 10, characterized in that the remote control is assigned an actuating means for controlling the intensity of the generated light beam and for turning at least one illuminant on and off.

13. Signaling device according to claim 1, characterized in that the remote control has an effective range of 300 to 400 meters.

14. Signaling device according to claim 1, characterized in that the wireless remote control is configured as an infrared radio control.

15. Signaling device in particular according to claim 1, characterized in that that a plurality of illuminants (16) differing in their respective power consumption are provided such that when the capacity of at least one source of current (17) drops below a given threshold value, only at least one illuminant (16) having the least power consumption is operated.

16. Signaling device according to claim 1, characterized in that the or each illuminant (16) is resiliently mounted in the housing (11) by means of a profile (19), made of elastic material, Which surrounds at least part of the respect illuminant (16).

17. Signaling device according to claim 1, characterized in that the housing (11) has means for the attachment of carrying means.

18. Signaling device according to claim 1, characterized in that the housing (11) has at least one base foot (14).

19. Signaling device according to claim 1, characterized in that an external source of current can be detachably connected to the or each accumulator (18).

20. Signaling device according to claim 1, characterized in that an external source of current can be detachably connected to at least one illuminant (16).

21. Signaling device according to claim 1, characterized in that the housing (16) essentially comprises one piece made of a plastic.
